(19) United States
(12) Patent Application Publication
(10) Pub. No.: US 2022/0023687 A1
(43) Pub. Date: Jan. 27, 2022

(54) FIRE GUARD

(71) Applicant: Shahriar Eftekharzadeh, Torrance, CA (US)

(72) Inventor: Shahriar Eftekharzadeh, Torrance, CA (US)

(21) Appl. No.: 16/939,012

(22) Filed: Jul. 26, 2020

(51) Int. Cl. A62C 3/02; E04D 12/00; E04H 9/14

(52) U.S. Cl. CPC A62C 3/0257; E04H 9/14; E04D 12/002; A62C 3/0214

(57) ABSTRACT

An apparatus for protecting structures against wildfires by means of thermal insulation.

### FIELD OF THE INVENTION

The present invention is in the field of covers and wraps for protection of structures against wildfires by means of thermal insulation.

### BACKGROUND OF THE INVENTION

The use of fire resistant fabric that reflects radiant heat to wrap structures for protecting against wildfires is a well proven and effective technique. Known as aluminized structure wrap, the fabric is woven from inflammable and heat resistant insulation materials such as fiberglass, a composite of aramid, carbon, and fiberglass, or amorphous silica, and is coated with reflective material such as aluminum foil to form an effective heat barrier. The aluminum surface reflects radiant heat while the inflammable heat-resistant fabric provides thermal insulation. The combined effect is to prevent the structure from reaching ignition temperature when exposed to intense external heat from a wildfire.

However, the challenge to successfully using aluminized structure wraps for wildfire protection is the practicality of wrapping a large structure in the short time available just before evacuating ahead of a fast approaching wildfire. The problem is where to house the large quantities of the heavy aluminized fabric, in a readily accessible location on or near the structure, and in a discrete and architecturally acceptable manner over the long periods of time that it is not needed, and how to make it rapidly deployable to wrap and protect the structure in the short time available ahead of a fast moving wildfire, without outside help. This challenge has been the subject of numerous patents over the years.

US patent application number US20170021208A1 provides an extensive account of the various fire protection fabric installation and deployment solutions and configurations. However, none of the techniques and processes disclosed have yielded practical solutions and none have gained widespread adoption as evidenced by the tragic loss of countless structures to wildfires annually.

Therefore, there is a need for a fire protection apparatus for structures, which is practical and effective such that it can gain widespread adoption and result in significant reduction in the loss of structures to wildfires.

### SUMMARY OF THE INVENTION

The present invention provides a solution to the above need by integrating the installation and use of aluminized structure wrap into the design and construction of existing and new structures as an essential element for fire safety and thermal insulation. The invention is comprised of two separate components; one for the structure roof, and the other for the structure walls.

For the structure roof, the invention integrates the use of aluminized structure wrap as a permanent component of the roof, either as the top surface exposed to the elements, or as a layer below conventional roof surfaces such as roof tiles or panels, separated by an air gap. As such, the permanent installation provides an optimal location to house the exact quantity of aluminized structure wrap needed to protect the roof against wildfires and eliminates the need for handling and deployment during the wildfire. The installation gives the roof an intrinsic property of not only being wildfire proof, but also thermally insulated and thus energy efficient and environmentally sustainable. Therefore, it provides year-round benefits as opposed to during rare wildfire events only. In both configurations, the aluminized structure wrap protects the roof by the aluminum surface reflecting the radiant heat away from the structure and by the heat resistant fabric insulating the structure below against heat conduction. In the configuration where the aluminized structure wrap is installed below the roof surface, either on the exiting roof surface or underlayment, the air gap is an essential feature that serves two critical functions. First, it eliminates conduction as a mechanism of heat transfer between the hot tiles and the aluminized wrap, thus leaving radiation as the only heat transfer mechanism, which the aluminum surface can reflect. Second, the air gap is continuous across the roof creating a duct for ventilation beneath the tile to transfer heat away from the structure by convection. For ease of construction, it may be advantegeous to have preassembled roof underlayment panels with top surface fitted with the aluminized structure wrap. Such underlayment panels may be used in lieu of conventional roof underlayment panels in new construction, or as replacement for existing roof underlayment. Similarly, it may be advantegeous to have preassembled roof panels already fitted with aluminized structure wrap on their underside separated by an air gap. Such preassembled roof panels may be used in lieu of conventional roof panels in new construction, or as replacement for existing roof panels.

For the structure walls, the invention integrates the use of aluminized structure wrap into both existing and future structures in the form of external sliding curtains that are normally open and discretely positioned to exposing the structure walls, windows, and doors, but which can rapidly close to cover over all vertical surfaces and thereby fully wrap around the entire structure. The sliding mechanism of the curtains of present invention is a key differentiating feature compared with prior art, which use rolling mechanism around a shaft supported on bearings at each end. Curtain rolls disclosed in prior art are impractical because the heavy weight of the fabric severely limits the span of the roll thus requiring many roll spans to cover a single wall. Also, rolls do not function on the gable end walls which have sloping upper sides.

The curtains of the present invention are suspended from trolleys in tracks and can cover any length of a wall in a single span. For gable end walls, at least two curtain tracks; one on each side of the ridge, is required to cover a wall. The curtain tracks are configured according to the structure architecture, geometry, and wall dimensions and may use one or more pieces to cover each wall as needed. The configuration is such that when the curtains are drawn open during normal times, they leave the walls, windows, and doors fully uncovered and exposed, and when drawn closed they fully cover all external wall surfaces to protect against a wildfire event. The curtains can also be used during normal times for thermal insulation when desired such as to shield against intense sunlight or to prevent heat loss from the structure during winter. The configuration is such that the curtains do not adversely affect the architecture and aesthetics of the structure. As with conventional sliding curtains operation can be either manual or power operated.

Another option for emergency or temporary protection of existing structure walls is to use the aforementioned preassembled underlayment panels by securing them over the wall surface using conventional fasteners. For such application, it would be advantageous to have the preassembled underlayment panels stored onsite. For permanent protection of structure walls, an assembly similar to the aforementioned preassembled roof panels may be uses. Such an assembly would consist of inflammable wall panels underlain by aluminized structure wrap separated by an air gap. Such preassembled wall panels may be used in lieu of conventional wall panels in new construction, as replacement for existing wall panels, or installed over existing wall surface.

It is an object of the present invention to provide a simple and effective apparatus for protecting structures against wildfire by means of thermal insulation, which can be widely adopted.

It is an object of this invention to provide improved elements and arrangements by apparatus for the purposes described thereof, which is comparable in cost with existing systems, dependable, and fully effective in accomplishing its intended purposes. These and other objects of the present invention will become readily apparent upon further review of the following specification and drawings.

### BRIEF DESCRIPTION OF THE DRAWINGS

FIG. 1 is a perspective view of a typical structure fitted with the apparatus of present invention for wildfire protection by thermal insulation when fully deployed. FIG. 1B shows the details of the wall curtain installation.

FIG. 2 is a perspective view of a typical structure fitted with the apparatus of present invention for wildfire protection by thermal insulation with wall curtains drawn open with some curtains having a portion of their lengths on the ground.

FIG. 3 is a perspective view of a typical structure fitted with the apparatus of present invention for wildfire protection by thermal insulation with wall curtains drawn open and folded up such that there is no portion of any curtain on the ground.

FIG. 4 is a perspective view of the structure in FIG. 3 equipped with housing facility for the curtains with housing doors open and the drawn curtains exposed.

FIG. 5 is a perspective view of the structure in FIG. 4 with the doors of the housing facilities for the curtains closed and the curtains contained inside.

FIG. 6 is a perspective view of the structure in FIG. 5 further fitted with battens over the aluminized structure wrap on the roof surface, to provide an air gap for placing roof tiles. FIG. 6B is a closeup showing the details in a portion of the roof.

FIG. 7 is a perspective view of the structure in FIG. 6 with roof tiles placed over battens leaving an air gap between the aluminized structure wrap and the roof tiles. FIG. 7B is a closeup showing the air gab.

FIG. 8 is a perspective view of the structure in FIG. 7 further fitted with rake tiles with an air gap between the rake tile and the roof fascia to permit ventilation. FIG. 8B is a closeup showing the air gap and the ventilation air flow.

FIG. 9 is a perspective view of the structure in FIG. 8 with wall curtains drawn fully closed.

FIG. 10 an expanded view of a preassembled underlayment panel.

FIG. 11 is a perspective view of a preassembled underlayment panel.

FIG. 11B shows the assembly detail of the preassembled underlayment panel.

FIG. 12 an expanded view of the preassembled roof/wall panel.

FIG. 13 is a perspective view of the preassembled roof/wall panel.

### DETAILED DESCRIPTION

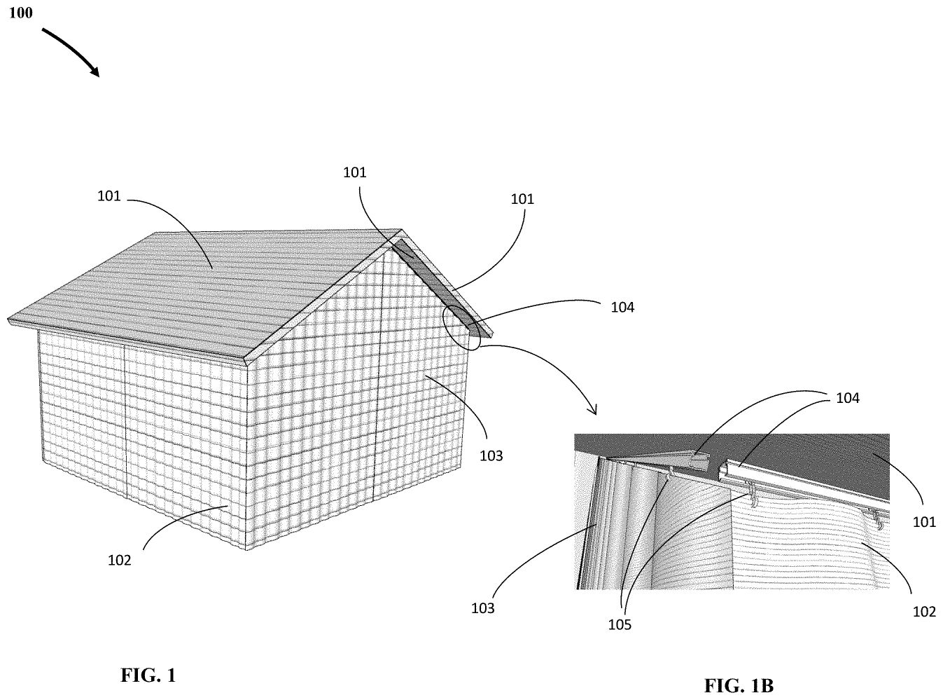

Referring to FIG. 1 and FIG. 1B, there is shown a perspective view of a typical structure fitted with apparatus (100) of present invention for wildfire protection by thermal insulation fully deployed. All external surfaces of the roof, including the fascia, soffit, hip, ridge, rake, plus any dormer, valley, and chimneys on all sides are fully and permanently covered over with aluminized structure wrap (101) with the aluminized surface on top. Aluminum foil is a durable material that has historically been used to cover over asphalt and bitumen roof tops to protect against drying and development of cracks. The present invention (100) extends the utility of aluminum foil covering for roofs to fire protection by thermal insulation by using it in the form of aluminized structure wrap (101) that covers not only the roof surface but also all other external surfaces of the roof The reflective surface is not restricted to aluminum foil and may be any other durable and suitable reflective material. FIG. 1 and FIG. 1B also shows that the structure walls are covered over with closed sliding curtains (102, 103) also made from aluminized structure wrap, hung from trolleys (105) inside tracks (104), which are secured to either the wall near the wall-soffit junction or the soffit. The sliding curtains (102, 103) are fitted to the structure in a manner to fully cover over all wall surfaces that make up the structure not leaving any expose wall surfaces and any gaps between the curtains. Adjacent curtains may be held firmly together by using clips (not shown) such as those used for fumigation tents.

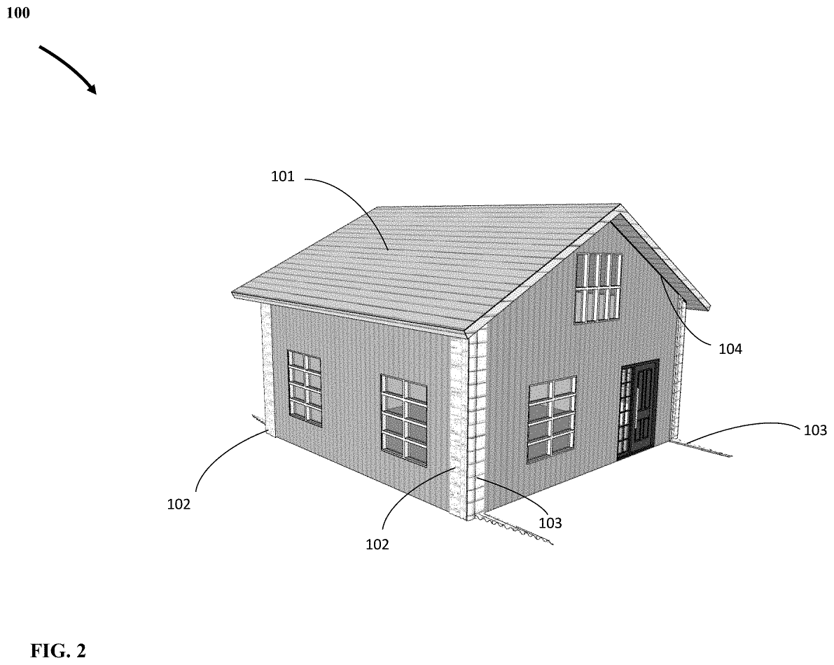

FIG. 2 shows the structure of FIG. 1 with sliding curtains (102, 103) drawn open thus exposing the walls, doors, and windows on all sides. FIG. 2 shows that because of the roof slope, curtains covering the gable end walls (103) have a longer length on one side and thus extend over the ground surface when drawn open. Curtains covering the side walls (102) have uniform length and do not have any portion extending over ground surface when drawn open.

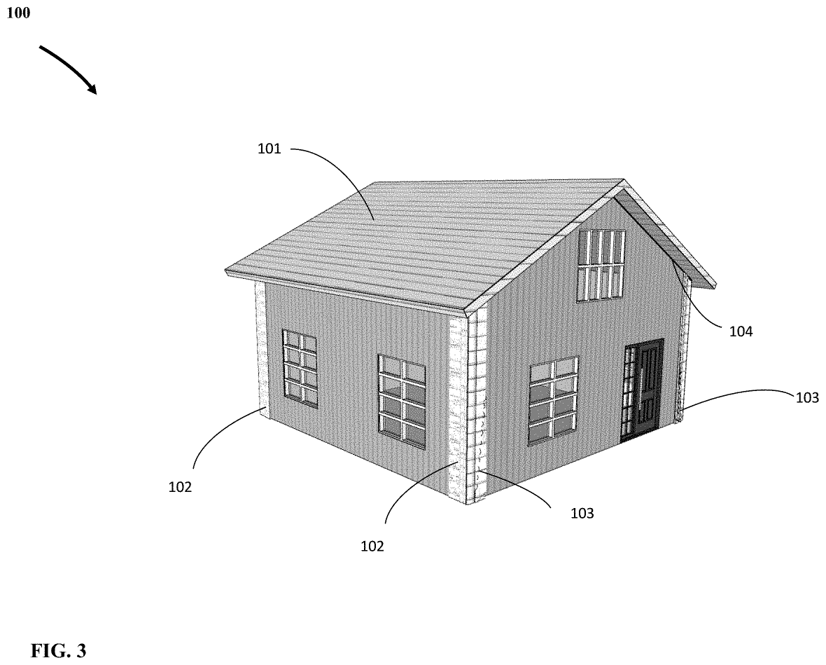

FIG. 3 shows those portions of curtains covering the gable end walls (103) which extend over the ground surface when drawn open folded up and fastened to the hanging portion of the curtain (103) for storage. The fully drawn open position of curtains (102, 103) is the place for their long term accommodation and storage, which its position and exact location on the wall may vary for different walls depending on the particular architecture of the structure, location of windows, doors, balcony, and other features of the structure. As with other sliding curtains, the fire curtains of present invention (102, 103) may be secured in drawn open position with straps or fitted with covers (not shown).

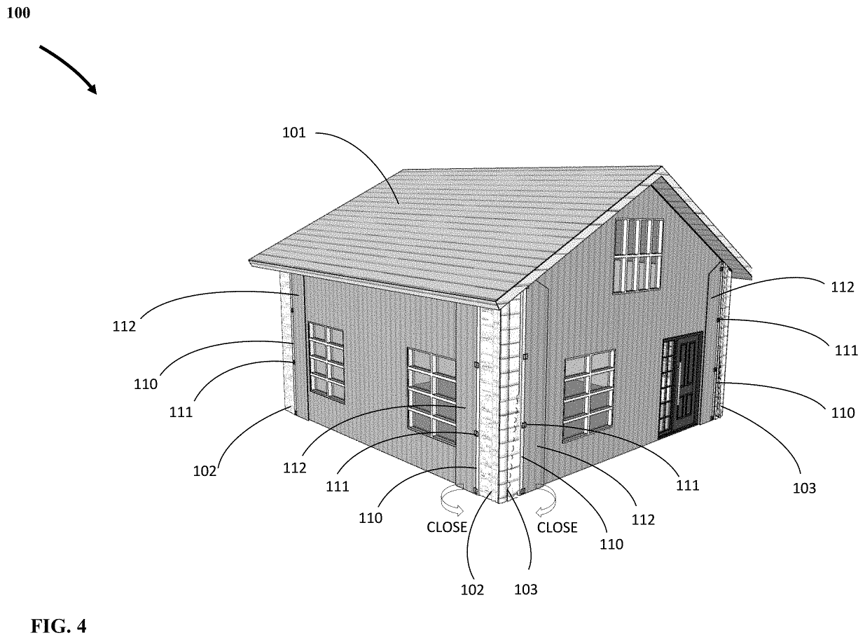

FIG. 4 shows one storage solution for curtains (102, 103) when drawn fully open in the form of slim outdoor closets, comprised of framing (110), door hinges (111), and closet doors (112) made from same material and pattern as the wall surface panels. Framing (110) is such that it provides minimum but adequate storage depth to store the curtains (102, 103) inside when closet door (112) is closed, but is slim enough not to obstruct the sliding action of curtains (102, 103). The position and opening direction of closet doors (112) is such that they swings fully open in the direction that curtains (102, 103) close and end up flush against the wall such that they are covered over by curtains (102, 103) when closed.

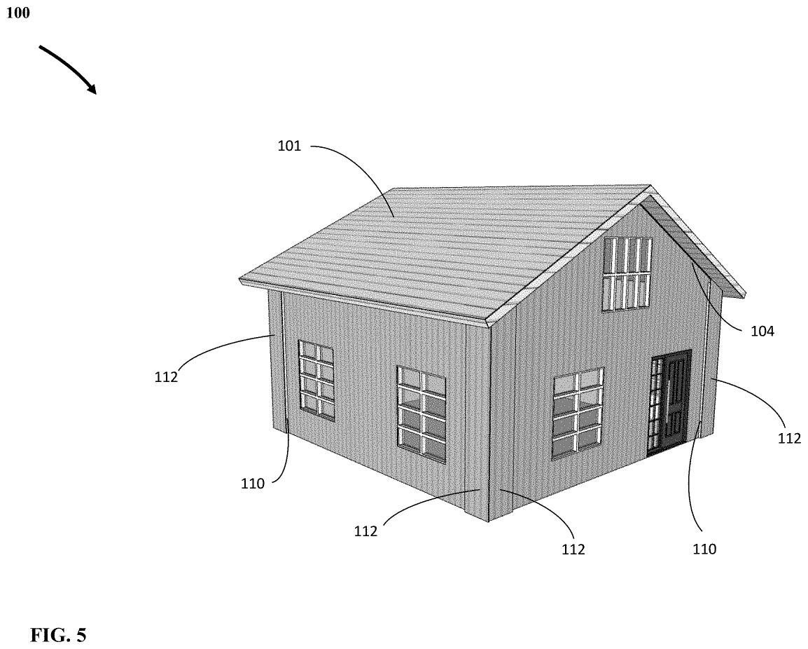

FIG. 5 shows the structure of FIG. 4 with closet door (112) in closed position thus housing curtains (102, 103) fully inside. The combination of slim framing (110) and closet doors (112) made from same material and pattern as the wall surface panels camouflages the storage closet for curtains (102, 103) such that they are nearly unperceivable and thus have minimal adverse impact on structure architecture.

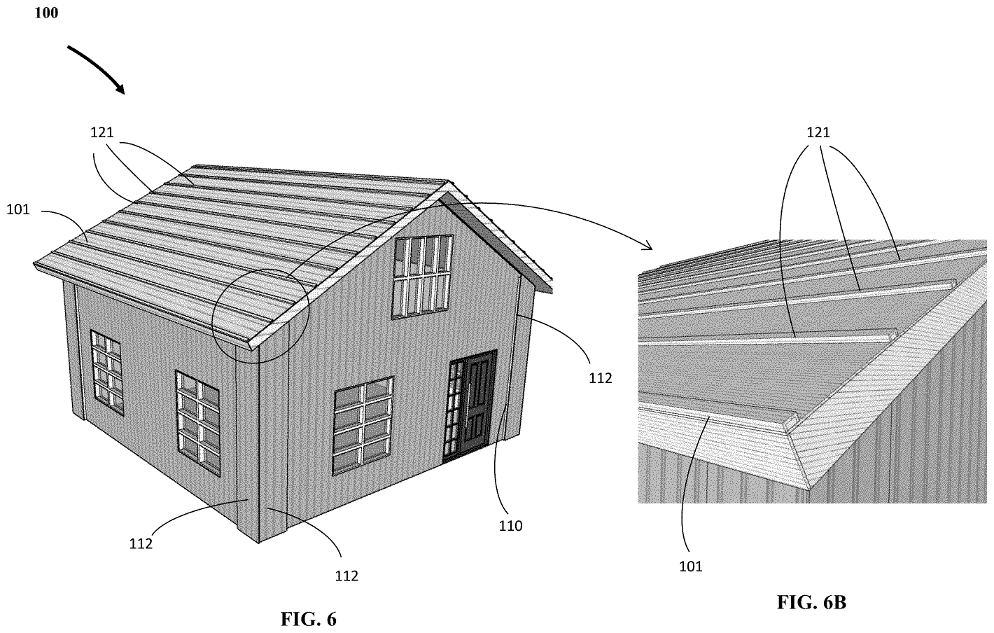

The present invention can accommodate customary roofing as roof tiles or panels over the aluminized structure wrap (101). FIG. 6 shows the structure of FIG. 5 further fitted with battens (121) on the roof. The batten (121) are either individually covered with aluminized structure wrap (101) as shown in FIG. 6B or may be placed on the roof surface first and then covered over with aluminized structure wrap (101). Either way, the purpose is to thermally insulate the battens (121) from the tiles or panels on top at point of contact while providing physical separation between the underside of the tiles and the surface of the aluminized structure wrap (101) on the roof surface.

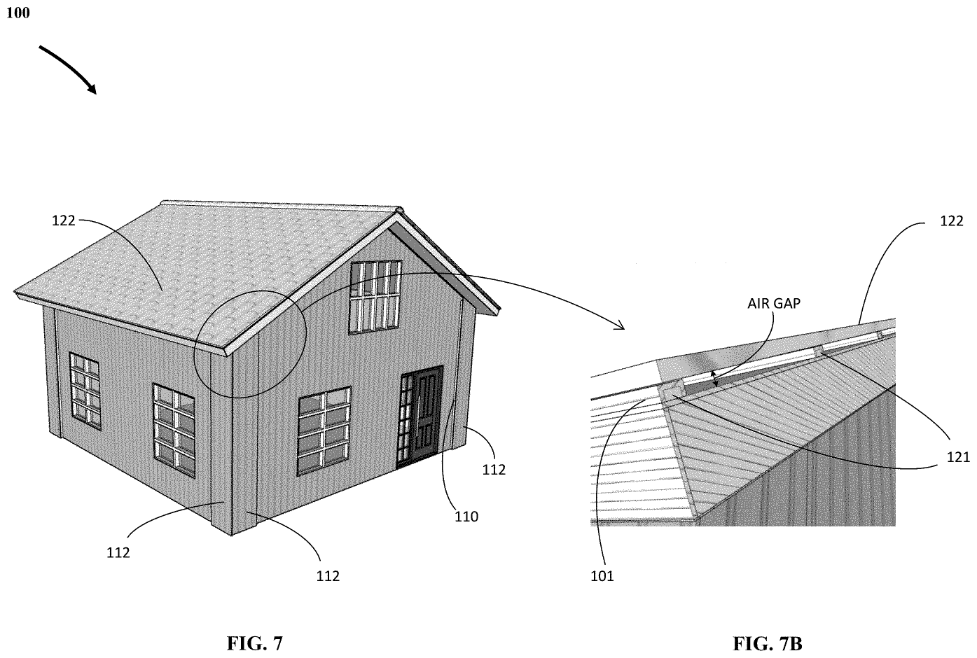

FIG. 7 shows the structure of FIG. 6 with tiles (122) placed atop and supported by battens (121) leaving an air gap in between. The air gap is an essential feature that serves two critical functions. First, it eliminates conduction as a mechanism of heat transfer between tiles (122) and aluminized structure wrap (101) on the roof surface, thus leaving radiation as the only mechanism for heat transfer, which surface of aluminized structure wrap (101) reflects. FIG. 7B is a closeup showing that the only location for conductive heat transfer is the contact between the batten (121) and the tile (122), which comprises a relatively small portion of the roof surface area and is insulated by the fabric (101). Second, with the air gap being continuous across the roof, it creates a duct for ventilation beneath the tile to transfer heat away from the roof surface and battens (121) by convection.

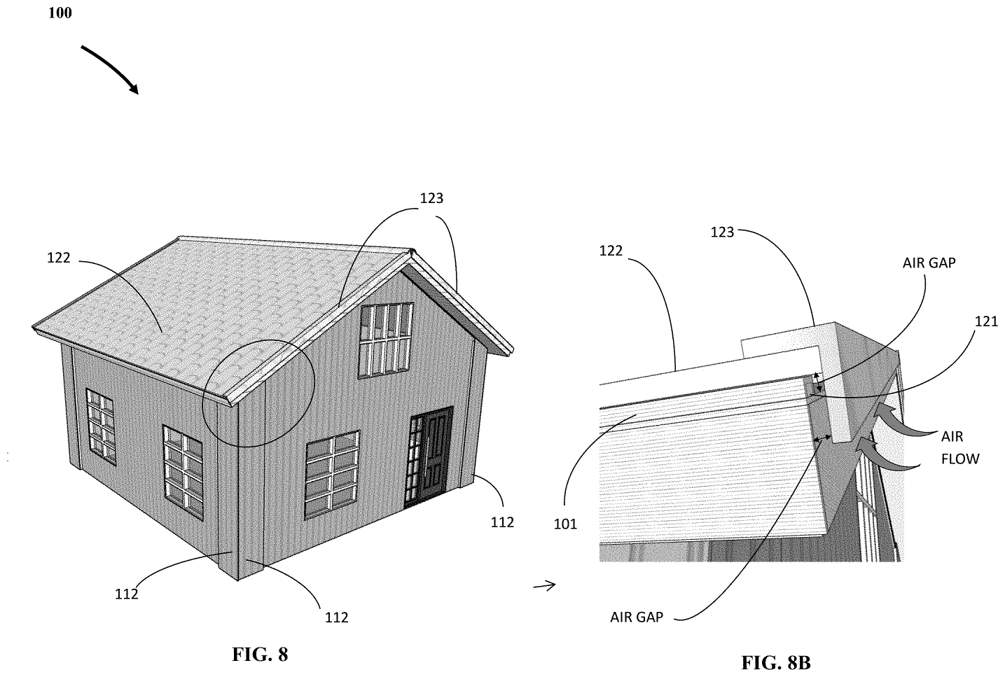

FIG. 8 shows the structure of FIG. 7 further fitted with rake tiles (123) in a manner that leaves an air gap between the tile (123) and fascia on the gable end. FIG. 8B is a closeup showing that this air gap connects to the air gap on the roof surface to create a continuous air duct the allows airflow between the roof tile (122) and roof surface covered with aluminized structure wrap (101) for heat transfer and cooling by convection.

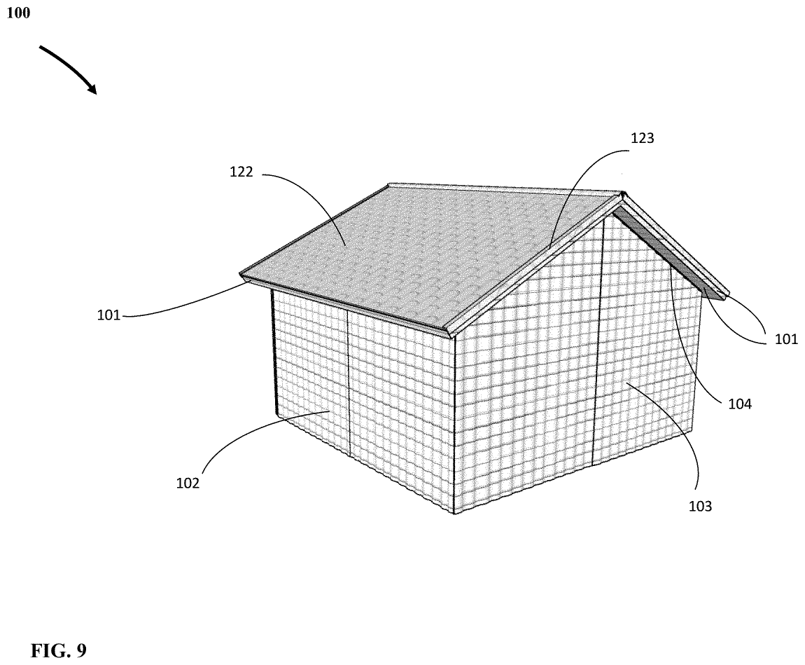

FIG. 9 shows the structure of FIG. 8 with curtains (102, 103) drawn fully closed. All external surfaces are fully wrapped with aluminized structure wrap to protected against wildfire or to provide thermal insulation.

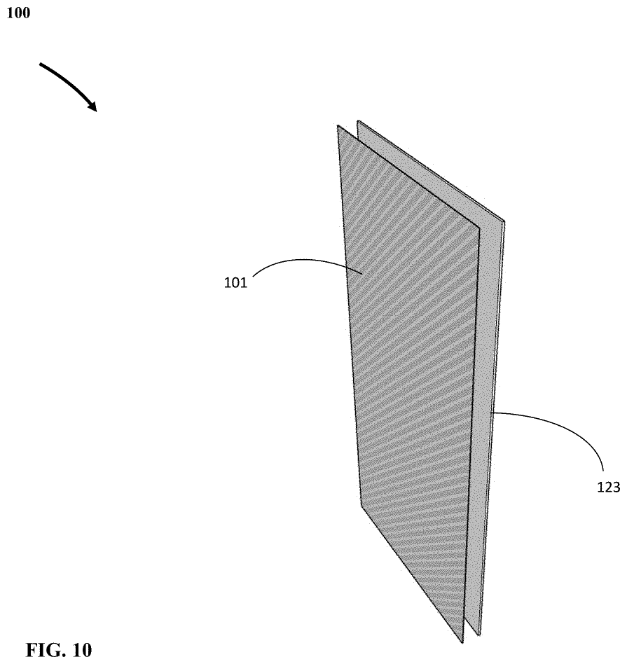

FIG. 10 shows the present invention (100) in the form of a composite preassembled underlayment panel comprised of underlayment panel (123) overlain by aluminized structure wrap (101).

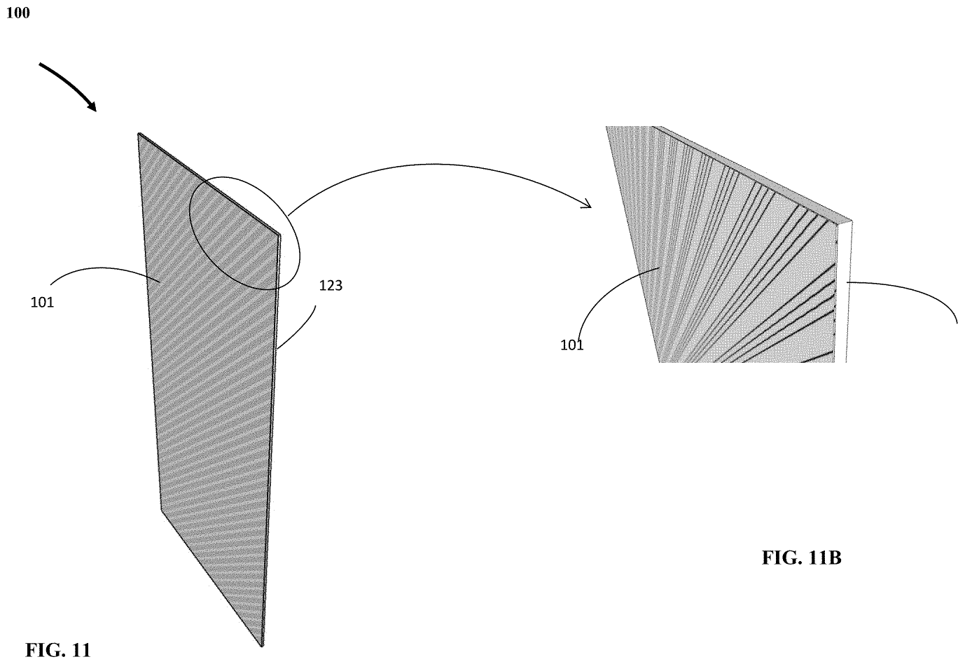

FIG. 11 is a perspective view of the composite underlayment panel of the present invention (100) with its two components: underlayment panel (123) and aluminized structure wrap (101), assembled to form a single item. FIG. 11B shows the details of the assembly. Various means of assembly may be used to attached and hold aluminized structure wrap (101) atop the underlayment panel (123). These include various types of fasteners, staples, glue, and laminating techniques.

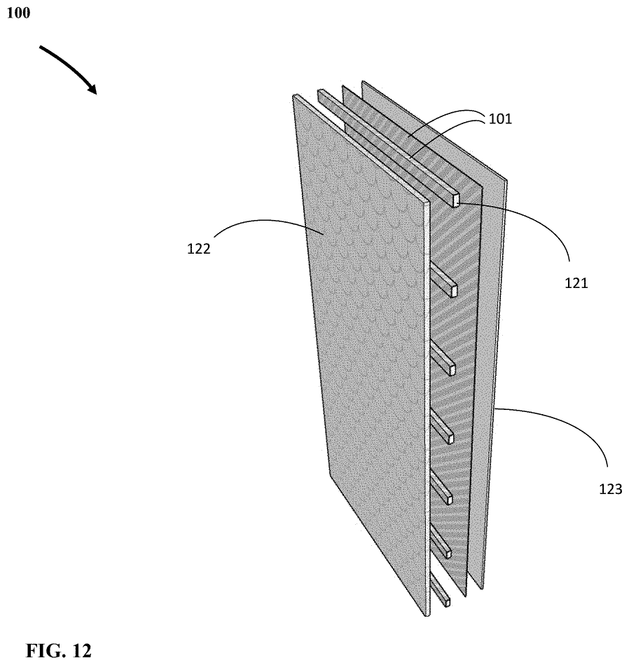

FIG. 12 shows present invention (100) in the form of a composite preassembled roof/wall panel comprised of underlayment panel (123) overlain by aluminized structure wrap (101) and battens (121) also covered with aluminized structure wrap (101) atop which there is an inflammable surface panel (122).

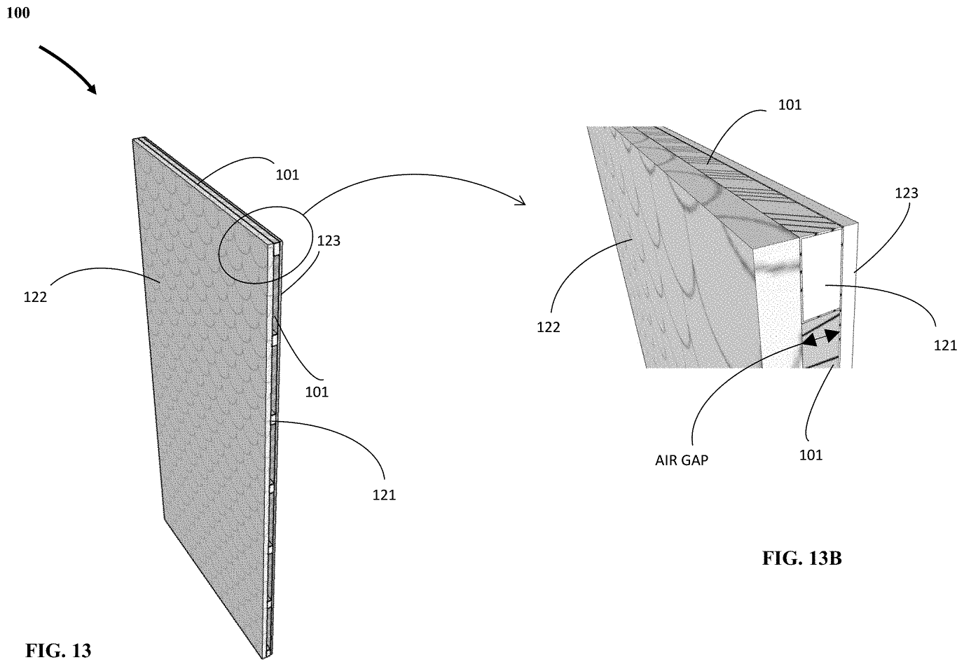

FIG. 13 shows a perspective view of the composite roof/wall panel of FIG. 12, assembled to form a single item. FIG. 13B shows the details of the assembly and the Air Gap. Various means of assembly may be used to attached and hold the underlayment panel (123), aluminized structure wrap (101), battens (121) covered with aluminized structure wrap (101) and the inflammable surface panel (122) together. These include various types of fasteners, staples, glue, and laminating techniques.

The present invention is susceptible to modifications and variations which may be introduced thereto without departing from the inventive concepts and the object of the invention. These may include various sliding mechanisms and means for securing and deployment of the wall curtains (102, 103) and their housing (110, 111, 112) on the structure walls, and various configurations and materials comprising the composite panels. Such variations are within the object and intent of the present invention.

While the present invention has been described in connection with what is considered the most practical and preferred embodiment, it is to be understood that the present invention is not to be limited to the disclosed arrangements, but is intended to cover various arrangements which are included within the spirit and scope of the broadest possible interpretation of the appended claims so as to encompass all modifications and equivalent arrangements which are possible.

1. An apparatus for protecting structures against wildfires the apparatus comprising:
a structure with roof and walls situated in a wildfire prone area;
curtain tracks mounted on external surfaces of said walls of said structure disposed to house trolleys that side inside said curtain tracks
curtains made from heat resistant inflammable material coated with reflective surface hung from and supported by said trolleys inside said curtain tracks. said curtains disposed to cover over external surfaces of said walls when closed by the action of said trolleys sliding inside said curtain tracks in one direction, with reflective surface of said inflammable material exposed, and substantially uncover said external surfaces of said walls when opened by the action of said trolleys sliding inside said curtain tracks in the opposite direction.

2. Apparatus of claim 1 wherein said external surfaces of said walls are equipped with slim unperceivable closets disposed to house said curtains when closed without negatively impacting the architecture of said structure.

3. An apparatus for protecting structures against wildfires the apparatus comprising:
a structure with roof and walls situated in a wildfire prone area
fabric made from heat resistant inflammable material coated with reflective surface disposed to cover over said roof of said structure and comprise an integral and permanent part of said roof
roof tiles disposed to cover over said fabric over said roof separated by an air gap

4. (canceled)

5. (canceled)

6. (canceled)

7. (canceled)

8. An apparatus for protecting structures against wildfires the apparatus comprising:
a structure with a roof and walls situated in a wildfire prone area
fabric made from heat resistant inflammable material coated with reflective surface disposed to affix to surface of construction panels to form composite panels, said composite panels disposed to be fastened to and cover over external surfaces of said roof and walls of said structure.

9. Apparatus of claim 8 wherein panels made from inflammable materials are fastened over reflective surface of said composite panels separated by an air gap.
